(19) United States
(12) Patent Application Publication
(10) Pub. No.: US 2015/0379610 A1
(43) Pub. Date: Dec. 31, 2015

(54) RECOMMENDATION INFORMATION PRESENTATION DEVICE, RECOMMENDATION INFORMATION PRESENTATION METHOD, AND RECOMMENDATION INFORMATION PRESENTATION PROGRAM

(71) Applicant: RAKUTEN INC., Tokyo (JP)

(72) Inventors: Zofia STANKIEWICZ, Tokyo (JP); Satoshi SEKINE, Tokyo (JP)

(73) Assignee: Rakuten, Inc., Tokyo (JP)

(21) Appl. No.: 14/765,380

(22) PCT Filed: Jul. 19, 2013
(86) PCT No.: PCT/JP2013/069682

§ 371 Date: Aug. 3, 2015

(51) Int. Cl. G06Q 30/06; G06F 17/27; G06F 17/30; G06F 3/0484

(52) U.S. Cl. CPC G06Q 30/0631; G06F 3/04842; G06F 17/2715; G06F 17/3053; G06F 17/30867

(57) ABSTRACT

A recommendation information presentation device includes a topic generation unit that mechanically classifies words extracted from text information about a plurality of products and generates a plurality of topics made up of a plurality of words, a product profile generation unit that generates a product profile indicating the tendency of distribution of words contained in the text information about products over topics, a presentation unit that presents words contained in at least two topics to a user terminal for each topic, an extraction unit that generates a user profile indicating the tendency of selection of a topic by a user based on selection of a topic by the user and extracts a product profile indicating the tendency of distribution that coincides with the tendency of selection with a certain degree or higher, and a recommendation information presentation unit that presents information about a product associated with the extracted product profile.

### TECHNICAL FIELD

The present invention relates to a recommendation information presentation device, a recommendation information presentation method, and a recommendation information presentation program.

### BACKGROUND ART

In a travel booking site, an electronic commerce site and the like, a technique that presents choices to a user in order to present facilities such as hotels and products desired by the user is known. For example, a device that, when a consumer makes a search for a product in an online store site, presents questions and choices to the consumer and then presents a product according to the choice selected by the consumer to the consumer is known (for example, see Patent Literature 1).

### CITATION LIST

### Patent Literature

PTL 1: Japanese Unexamined Patent Application Publication No. 2002-41531

### SUMMARY OF INVENTION

### Technical Problem

In the above-described related art, it is necessary to make an association between choices for questions to a customer and products to be presented to the consumer in advance. Further, if a service provider makes this association manually, it takes a lot of time and effort, and further the association is biased by the provider.

In view of the above, an object of the present invention is to, when presenting information related to a product based on an answer from a consumer, make an association between an answer from a consumer and a product easily without human intervention, eliminating the bias by a provider of the product.

### Solution to Problem

In order to solve the above problem, a recommendation information presentation device according to one aspect of the present invention includes a topic generation means configured to mechanically classify words extracted from text information about a plurality of products and generate a plurality of topics made up of one or more classified words, a product profile generation means configured to generate a product profile containing a frequency of appearance of words in each topic obtained by classifying the words contained in the text information about products into one or more topics for each of the products, a topic presentation means configured to present words contained in at least two topics among the topics generated by the topic generation means to a user terminal for each topic, a receiving means configured to receive selection of a topic from the user terminal in response to presentation of topics by the topic presentation means, and a recommendation information presentation means configured to present information about a product associated with the product profile in accordance with a tendency of selection of a topic by a user of the user terminal received by the receiving means as recommendation information to the user terminal.

A recommendation information presentation method according to one aspect of the present invention is a recommendation information presentation method in a recommendation information presentation device for presenting recommendation information about a product to a user terminal, the method including a topic generation step of mechanically classifying words extracted from text information about a plurality of products and generating a plurality of topics made up of one or more classified words, a product profile generation step of generating a product profile containing a frequency of appearance of words in each topic obtained by classifying the words contained in the text information about products into one or more topics in association with each of the products, a topic presentation step of presenting words contained in at least two topics among the topics generated in the topic generation step to a user terminal for each topic, a receiving step of receiving selection of a topic from the user terminal in response to presentation of topics in the topic presentation step, and a recommendation information presentation step of presenting information about a product associated with the product profile in accordance with a tendency of selection of a topic by a user of the user terminal received in the receiving step as recommendation information to the user terminal.

A recommendation information presentation program according to one aspect of the present invention is a recommendation information presentation program for causing a computer to function as a recommendation information presentation device for presenting recommendation information about a product to a user terminal, the program causing the computer to implement a topic generation function to mechanically classify words extracted from text information about a plurality of products and generate a plurality of topics made up of one or more classified words, a product profile generation function to generate a product profile containing a frequency of appearance of words in each topic obtained by classifying the words contained in the text information about products into one or more topics for each of the products, a topic presentation function to present words contained in at least two topics among the topics generated by the topic generation function to a user terminal for each topic, a receiving function to receive selection of a topic from the user terminal in response to presentation of topics by the topic presentation function, and a recommendation information presentation function to present information about a product associated with the product profile in accordance with a tendency of selection of a topic by a user of the user terminal received by the receiving function as recommendation information to the user terminal.

According to the above aspects, topics formed by mechanically classifying words extracted from text information about products are presented to a user, a product where the tendency of selection of a topic by a user coincides with the tendency of distribution of words contained in the text information about products over topics with a certain degree or higher is extracted, and information about the extracted product is presented as recommendation information to the user. Specifically, topics are generated mechanically without human intervention. Further, the extraction of a product to be presented according to the tendency of selection of a topic by a user is performed based on the distribution of words contained in the text information about products over topics. Thus, it is possible to make association between a topic to be selected by a user and a product to be presented to the user easily without human intervention and without any bias by a provider of the product.

In the recommendation information presentation device according to another aspect, the topic presentation means may present two topics, and the receiving means may receive selection of any one topic among the two topics presented by the topic presentation means.

According to this aspect, a user only needs to make a decision to select a topic on which the user places greater importance among two topics, and the user can thereby easily give an answer about selection.

In the recommendation information presentation device according to another aspect, the topic presentation means may calculate a degree of similarity between a word contained in one topic generated by the topic generation means and a word contained in another topic generated by the topic generation means as a distance between topics, and present the one topic and the another topic with a predetermined distance or more.

According to this aspect, because two topics distant from each other are presented to a user, it is possible to more effectively acquire the tendency of selection of a topic on which the user places importance. Further, because the user selects either one of the topics with a long distance, the user can easily make a decision about selection.

In the recommendation information presentation device according to another aspect, the topic presentation means may select one topic generated by the topic generation means, specify another topic in which a frequency of appearance of a word is less than a predetermined frequency in any product profile where a frequency of appearance of the word contained in the one selected topic is equal to or more than a predetermined frequency, and present the one topic and the another topic.

According to this aspect, the word contained in the specified another topic appears less frequently in the product profile of any product to be presented to the user terminal when one topic is selected by the user. Thus, a set of products to be presented when another topic is selected is totally different from a set of products to be presented when one topic is selected. By presenting the one selected topic and the specified another topic in this manner, a user can easily make a decision about selection.

In the recommendation information presentation device according to another aspect, the topic presentation means may present three or more topics, and the receiving means may receive selection of at least one topic among the three or more topics presented by the topic presentation means.

According to this aspect, because three or more topics are presented to a user, it is possible to enhance the possibility that the topic on which a user places importance is included in the presented topics. Accordingly, the topic on which a user places importance can be specified easily.

In the recommendation information presentation device according to another aspect, the receiving means may receive selection of one or more topics with weights, and the recommendation information presentation means may present the recommendation information based on the tendency of selection by a user indicated by the selection of topics with weights.

According to this aspect, because selection of topics with weights is received, it is possible to specify the tendency of selection of a topic by a user in detail.

In the recommendation information presentation device according to another aspect, when selection of one or more topics with a predetermined amount or more of weights is received from the user terminal by the receiving means, the topic presentation means may present a plurality of sub-topics made up of a plurality of words formed by mechanically classifying a plurality of words contained in the topic to the user terminal.

According to this aspect, because words contained in a topic selected with a predetermined amount or more of weights are further classified into sub-topics, and selection of a sub-topic can be received, it is possible to specify the tendency of selection of a topic by a user in detail.

In the recommendation information presentation device according to another aspect, the topic presentation means may present a merged topic where a plurality of topics other than a topic for which selection with a predetermined amount or more of weights is received among a plurality of topics presented to the user terminal are merged to the user terminal.

According to this aspect, a plurality of topics not selected with a predetermined amount or more of weights by a user are merged as a merged topic, and thereby the number of topics on which the user does not place importance is reduced, which makes it easier to select a topic on which the user places importance.

### Advantageous Effects of Invention

According to one aspect of the present invention, when presenting information related to a product based on an answer from a consumer, it is possible to make an association between an answer from a consumer and a product easily without human intervention, eliminating the bias by a provider of the product.

### BRIEF DESCRIPTION OF DRAWINGS

FIG. 1 is a view showing a configuration of a system including a recommendation information presentation device.

FIG. 2 is a block diagram showing a functional configuration of a recommendation information presentation device.

FIG. 3 is a view showing a hardware configuration of a recommendation information presentation device.

FIG. 4 is a view schematically showing an example of topics stored in a topic storage unit.

FIG. 5 is a view schematically showing an example of product profiles stored in a product profile storage unit.

FIG. 6 is a view showing an example of topics displayed on a user terminal.

FIG. 7 is a view schematically showing an example of selection of a topic.

FIG. 8 is a view schematically showing an example of selection of a topic in the case where three or more topics are presented to a user terminal.

FIG. 9 is a view illustrating another example of presentation of topics by a topic presentation unit.

FIG. 10 is a flowchart showing an example of a process of a recommendation information presentation method.

FIG. 11 is a view showing a configuration of a recommendation information presentation program.

### DESCRIPTION OF EMBODIMENTS

An embodiment of the present invention is described hereinafter in detail with reference to the appended drawings. Note that, in the description of the drawings, the same or equivalent elements are denoted by the same reference symbols, and the redundant explanation thereof is omitted.

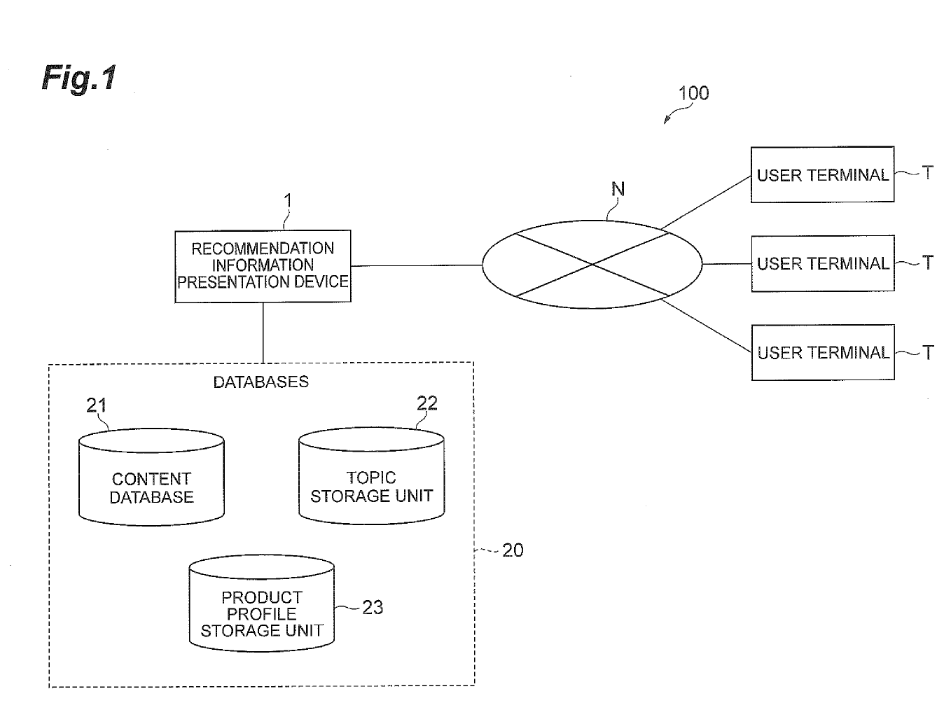

FIG. 1 is a view showing a configuration of a recommendation information presentation system 100 that includes a recommendation information presentation device according to this embodiment. A recommendation information presentation device 1 is a part of an e-commerce site that provides products to users, for example. As shown in FIG. 1, the recommendation information presentation system 100 includes the recommendation information presentation device 1, user terminals T and databases 20. The user terminals T and the recommendation information presentation device 1 are connected through a network N such as the Internet. The recommendation information presentation device 1 can access the databases 20 through a network such as the Internet or a private line. Although three user terminals T are shown in FIG. 1, the number of user terminals T is not particularly limited. The databases 20 include a content database 21, a topic storage unit 22, and a product profile storage unit 23.

The content database 21 is a database that stores information about products to be provided to users. The information about products contains text information indicating the features and attributes of the products. Note that the products are all properties to be provided to users, which are the concept including objects, services, travel booking and the like, for example.

The topic storage unit 22 is a storage means that stores topics generated by the recommendation information presentation device 1. The topic is a set of words mechanically extracted from the text information about products and classified using a mechanical clustering technique such as LDA (Latent Dirichlet Allocation), for example.

The product profile storage unit 23 is a storage means that stores a product profile for each product. The product profile is information indicating the tendency of distribution of a plurality of words contained in the text information about a product over topics.

The variety of the user terminals T is not particularly limited, and it may be a stationary or portable personal computer, or a mobile terminal such as an advanced mobile phone (smart phone), a cellular phone or a personal digital assistant (PDA), for example.

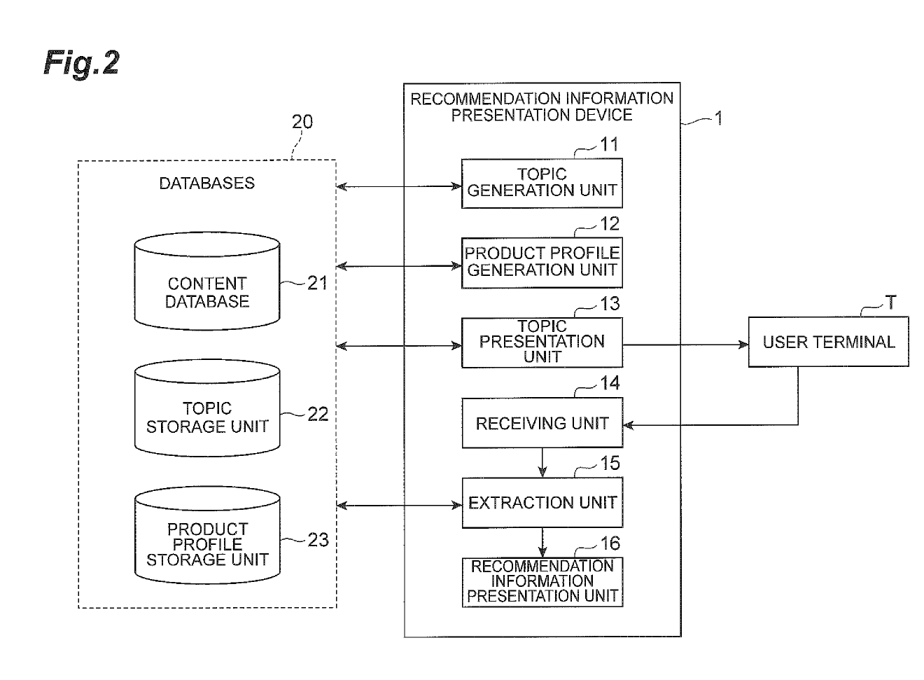

FIG. 2 is a block diagram showing a functional configuration of the recommendation information presentation device 1 according to this embodiment. The recommendation information presentation device 1 is a device that presents recommendation information for a product to the user terminal T, and it is configured as a computer such as a server, for example.

To be more specific, the recommendation information presentation device 1 presents a plurality of topics to a user, receives selection of a topic from the user, and then presents recommendation information for a product to the user according to the tendency of selection of a topic received. The recommendation information presentation device 1 according to this embodiment makes an association between a selected topic and a product for which recommendation information is to be presented mechanically without human intervention, and it is thereby possible to eliminate the bias by a provider of a product in the extraction of recommendation information to be presented and present the recommendation information easily.

As shown in FIG. 2, the recommendation information presentation device 1 according to this embodiment functionally includes a topic generation unit 11 (topic generation means), a product profile generation unit 12 (product profile generation means), a topic presentation unit 13 (topic presentation means), a receiving unit 14 (receiving means), an extraction unit 15 (recommendation information presentation means), and a recommendation information presentation unit 16 (recommendation information presentation means). Further, the functional units 11 to 16 of the recommendation information presentation device 1 can access the databases 20.

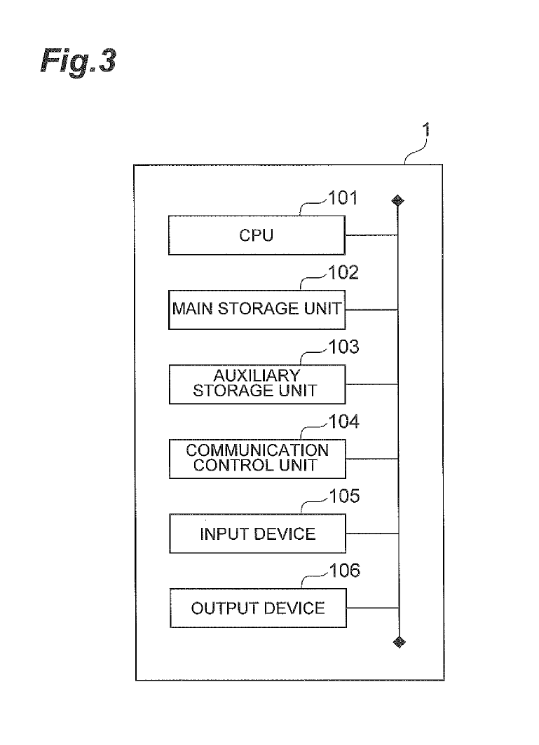

FIG. 3 is a hardware configuration diagram of the recommendation information presentation device 1. As shown in FIG. 3, the recommendation information presentation device 1 is physically configured as a computer system that includes a CPU 101, a main storage device 102 such as memory like RAM and ROM, an auxiliary storage device 103 such as a hard disk, a communication control device 104 such as a network card, an input device 105 such as a keyboard and a mouse, an output device 106 such as a display and the like.

The functions shown in FIG. 2 are implemented by loading given computer software (recommendation information presentation program) onto hardware such as the CPU 101 or the main storage device 102 shown in FIG. 3, making the communication control device 104, the input device 105 and the output device 106 operate under control of the CPU 101, and performing reading and writing of data in the main storage device 102 or the auxiliary storage device 103. Data and database required for the processing is stored in the main storage device 102 or the auxiliary storage device 103.

The functional units of the recommendation information presentation device 1 are described hereinbelow. The topic generation unit 11 is a part that generates a topic made up of one or more words. To be specific, the topic generation unit 11 mechanically extracts words from the text information about a plurality of products acquired from the content database 21 by a technique such as morphological analysis, for example. The words to be extracted are a noun, an adjective and the like, for example. The text information about a product is users' reviews on the product, description of the product, attribute information of the product and the like, for example.

Next, the topic generation unit 11 mechanically classifies the words extracted from the text information using a clustering technique such as LDA (Latent Dirichlet Allocation), for example. The topic generation unit 11 then stores a set of the classified words as a topic into the topic storage unit 22.

Note that the topic generation unit 11 may refrain from classifying the words that are contained in the most text information into topics. For example, when the product is a travel or accommodation service and the text information about products is reviews on accommodation facilities, the words such as “hotel” and “review” are not classified into topics.

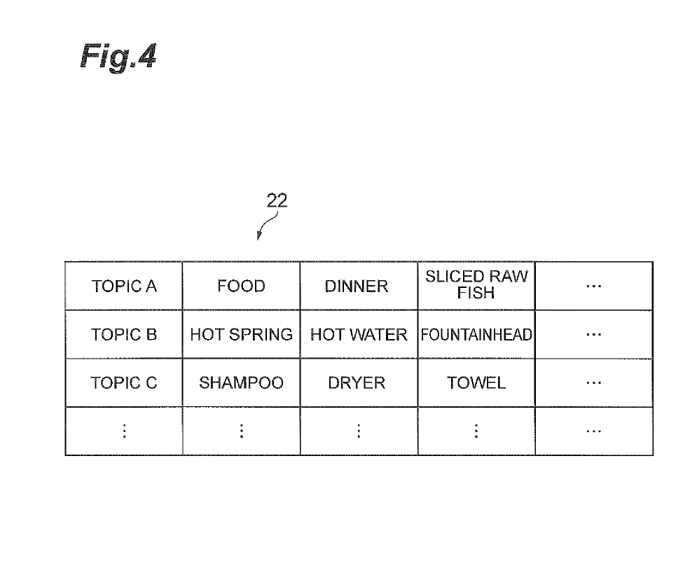

FIG. 4 is a view schematically showing an example of topics stored in the topic storage unit 22. As shown in FIG. 4, the topic storage unit 22 stores a plurality of topics such as Topics A, B, C and so on. Topic A contains words such as food, dinner and sliced raw fish. Topic B contains words such as hot spring, hot water and fountainhead. Topic C contains words such as shampoo, dryer and towel. Because those topics are generated mechanically, it does not contain the bias by a provider of the product.

The product profile generation unit 12 is a part that generates, for each product, a product profile containing the frequency of appearance of words in each topic which is obtained by classifying the words contained in the text information about products into one or more topics. To be specific, the product profile generation unit 12 summarizes, for each product, the number of appearances of the words in each topic stored in the topic storage unit 22 in the text information about products stored in the content database 21. Then, the product profile generation unit 12 stores the summarized information as a product profile for each product into the product profile storage unit 23.

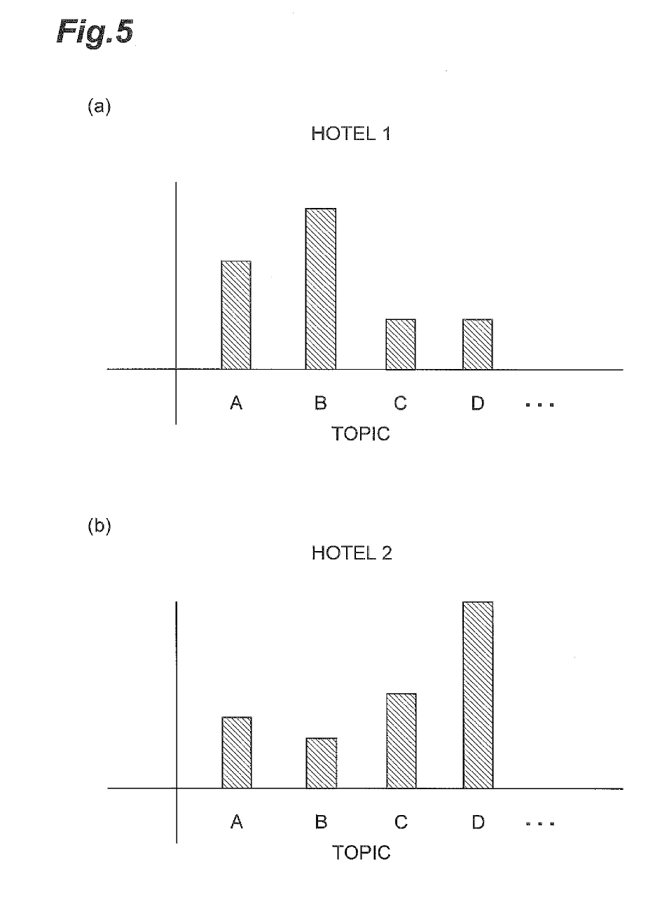

FIG. 5 is a view schematically showing an example of product profiles stored in the product profile storage unit 23 in the case where the product is an accommodation service of accommodation facilities (hotels), for example. FIG. 5(a) shows the product profile of a hotel 1 as an accommodation facility, and how many words in each topic the text information such as reviews about the hotel 1 contains is represented in a bar graph. According to FIG. 5(a), the text information about the hotel 1 contains a relatively large number of the words in Topic B. On the other hand, FIG. 5(b) shows the product profile of a hotel 2 as an accommodation facility, and how many words in each topic the text information such as reviews about the hotel 2 contains is represented in a bar graph. According to FIG. 5(b), the text information about the hotel 2 contains a relatively large number of the words in the topic D.

Note that, because FIG. 5 shows an example of product profiles in a schematic manner, the product profile may be generated as vector data having the number and proportion of words in each topic contained in the text information about products as elements, for example. Further, the number of words in each topic contained in the text information may be normalized as appropriate.

The topic presentation unit 13 is a part that presents the words contained in at least two of the topics generated by the topic generation unit 11 for each topic to the user terminal T.

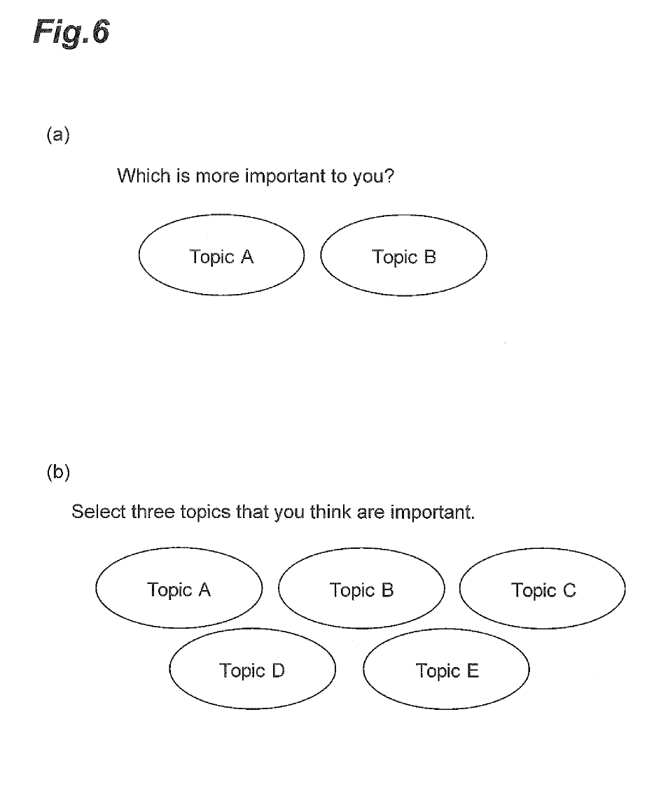

The topic presentation unit 13 displays two topics and the words contained in those topics on the user terminal T, for example. FIG. 6(a) is a view showing an example of topics displayed on the user terminal T. As shown in FIG. 6(a), the topic presentation unit 13 displays the two topics, Topic A and Topic B, together with a message such as “Which is more important to you?” on the user terminal T, for example. Note that, the words contained in the topic are displayed in the frame of each topic, though not shown.

Note that the topic presentation unit 13 may calculate the degree of similarity between a word contained in one topic and a word contained in another topic as a distance between topics and present the one topic and another topic with a certain distance or more. The degree of similarity between words can be obtained by analyzing them using a known language processing technique. By presenting the topics in this manner, it is possible to more effectively acquire the tendency of selection of a topic on which a user places importance. Further, because a user selects either one of the topics with a long distance, the user can easily make a decision about selection.

Further, the topic presentation unit 13 may select one topic among the topics generated by the topic generation unit 11, specify another topic in which the frequency of appearance of a word is less than a predetermined frequency in the product profile where the frequency of appearance of the word contained in one selected topic is equal to or more than a predetermined frequency, and present the one topic and another topic. If any given two topics are presented, a user might hesitate over which of the two to prefer. However, the word contained in another topic specified in this manner appears less frequently in the product profile of any product to be presented to the user terminal when one topic is selected by the user. Accordingly, a set of products to be presented when another topic is selected would be totally different from a set of products to be presented when one topic is selected. By presenting the one selected topic and the specified another topic in this manner, a user can easily make a decision about selection.

Further, the topic presentation unit 13 may display three or more topics and the words contained in those topics on the user terminal T. FIG. 6(b) is a view showing an example of topics displayed on the user terminal T. As shown in FIG. 6(b), the topic presentation unit 13 displays the five topics, Topics A to E, together with a message such as “Select three topics that you think are important” on the user terminal T, for example. Note that, the words contained in the topic are displayed in the frame of each topic, though not shown. By presenting three or more topics in this manner, the possibility that the topic on which a user places importance is included in the presented topics increases. Accordingly, the topic on which a user places importance can be specified easily.

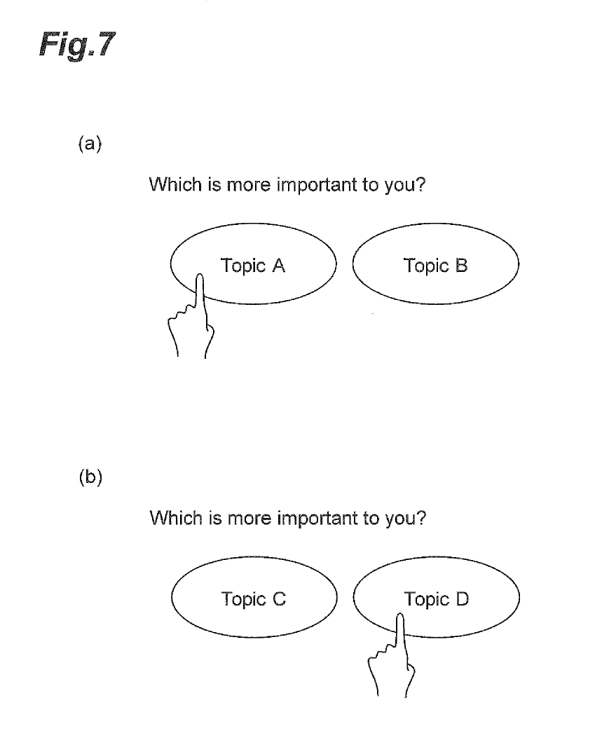

The receiving unit 14 is a part that receives selection of a topic from the user terminal T which has been made in response to presentation of topics by the topic presentation unit 13. FIG. 7 is a view schematically showing an example of selection of a topic. In the example of FIG. 7(a), a user selects Topic A among Topic A and Topic B presented by the topic presentation unit 13. In response to the selection, the receiving unit 14 receives information indicating that Topic A is selected. In the example of FIG. 7(b), a user selects Topic D among Topic C and Topic D presented by the topic presentation unit 13. In response to the selection, the receiving unit 14 receives information indicating that Topic D is selected.

As a result that the receiving unit 14 receives selection of Topic A and Topic D, the recommendation information presentation device 1 can recognize that the user places importance on Topics A and D. Further, by receiving selection of Topic A and Topic D, the extraction unit 15 can generate a user profile indicating such tendency of selection as described later. Note that the receiving unit 14 may receive selection of a topic which a user does not place importance on.

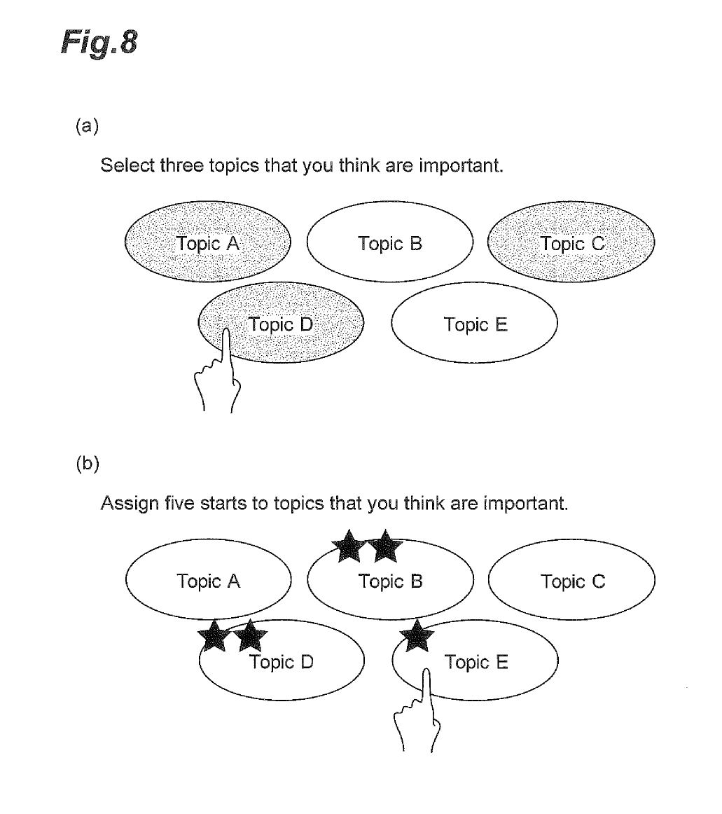

FIG. 8 is a view schematically showing an example of selection of a topic in the case where three or more topics are presented to the user terminals T. In the example of FIG. 8(a), a user selects Topics A, C and D among Topics A to E presented by the topic presentation unit 13. In response to the selection, the receiving unit 14 receives information indicating that Topics A, C and D are selected.

Further, the receiving unit 14 may receive selection of one or more topics with weights in response to presentation of three or more topics. FIG. 8(b) is a view schematically showing an example of selection of topics with weights. In this case, the topic presentation unit 13 displays the five topics, Topics A to E, together with a message such as “Assign five starts to topics that you think are important” on the user terminal T, for example. Then, after selection that represents weights by the number of stars is made on the user terminals T, the receiving unit 14 receives selection of Topic B and Topic D with the weight “2” and selection of Topic E with the weight “1”.

The extraction unit 15 is a part that acquires the product profile in accordance with the tendency of selection of a topic by a user of the user terminal which has been received by the receiving unit 14. To be specific, the extraction unit 15 generates a user profile, which is information indicating the tendency of selection of a topic by a user, based on the selection of a topic by the user of the user terminal received by the receiving unit 14, and extracts the product profile where the tendency of selection indicated by the user profile and the tendency of distribution of the frequency of appearance of words in each topic coincide with a certain degree or higher, for example.

The extraction unit 15 can generate the user profile indicating the tendency of selection of a topic by a user as vector data, for example. In the case where selection of a topic by a user as in the example of FIG. 7 is received by the receiving unit 14, the extraction unit 15 generates vector data (1,0,0,1, . . . ) with the elements representing the presence or absence of selection of Topics A, B, C, D, . . . as the user profile.

In the case where selection of topics by a user as in the example of FIG. 8(a) is received by the receiving unit 14, the extraction unit 15 generates vector data (1,0,1,1,0, . . . ) with the elements representing the presence or absence of selection of Topics A, B, C, D, E, . . . as the user profile.

In the case where selection of topics by a user as in the example of FIG. 8(b) is received by the receiving unit 14, the extraction unit 15 generates vector data (0,2,0,2,1, . . . ) with the elements representing the weights on Topics A, B, C, D, E, . . . as the user profile.

Note that, although the examples in which the user profile is generated as vector data are described above, the user profile is not limited to the vector and may be in any format as long as it is a data format capable of representing the tendency of selection of a topic by a user.

Then, the extraction unit 15 extracts the product profile indicating the tendency of distribution that coincides with the tendency of selection of a topic indicated by the generated user profile with a certain degree or higher from the product profile storage unit 23. As described earlier, the product profile storage unit 23 stores information indicating the tendency of distribution of words contained in the text information about products over topics as the product profile for each product. In the case where both of the user profile and the product profile are generated as vector data, the extraction unit 15 can obtain the degree of coincidence between the user profile and the product profile by calculating the distance between the vectors.

Further, the extraction unit 15 may extract the product profile without calculating the user profile as vector data. To be specific, as shown in FIG. 8(b), when selection of Topic B and Topic D with the weight “2” and selection of Topic E with the weight “1” are received by the receiving unit 14, the extraction unit 15 extracts the product profile indicating inclusion of a predetermined amount or more of words contained in Topics B, D and E. Then, because the weight on Topics B and D is greater than the weight on Topic E, the extraction unit 15 may retrieve the product profile indicating that the amount of words in each topic contained in the text information about products is the greatest in Topics B, D and E or Topics D, B and E in descending order.

The recommendation information presentation unit 16 is a part that presents information about a product which is associated with the product profile acquired by the extraction unit 15 as recommendation information to the user terminal T. Because the product profile that coincides with the tendency of selection of a topic indicated by the user profile of a user with a certain degree or higher is extracted by the extraction unit 15, the product of the extracted product profile is likely to have the elements on which a user places importance. The recommendation information presentation unit 16 acquires information about the product of the extracted product profile from the content database 21 and presents the acquired information as recommendation information to the user terminal T.

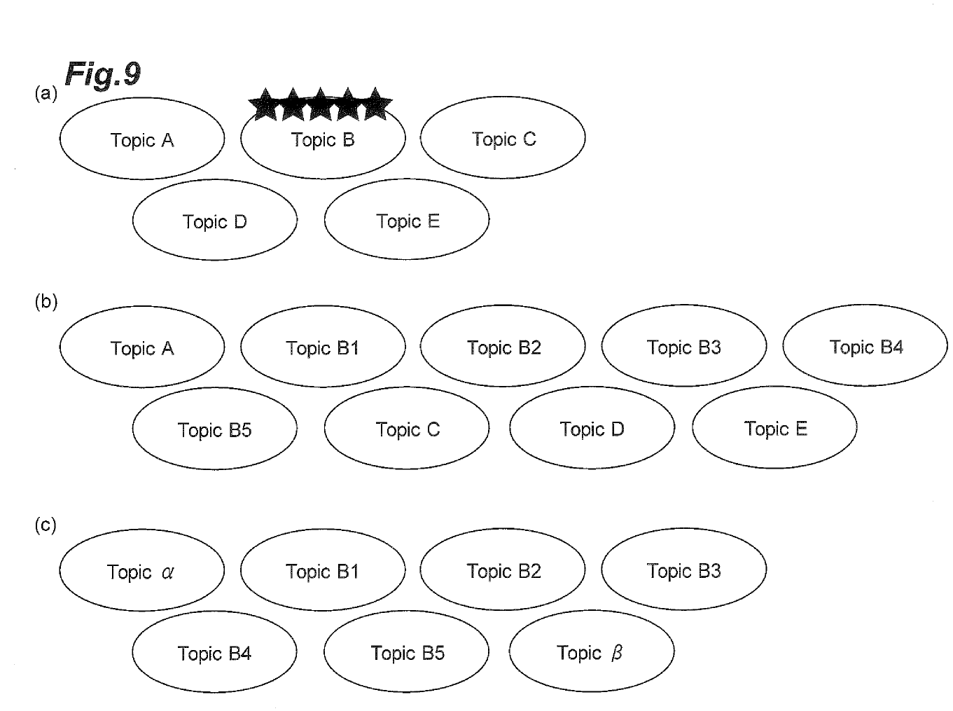

Another example of presentation of topics by the topic presentation unit 13 is described hereinafter with reference to FIG. 9. When selection of one or more topics with a predetermined amount or more of weights is received from the user terminal T by the receiving unit 14, the topic presentation unit 13 may present a plurality of sub-topics made up of a plurality of words formed by mechanically classifying a plurality of words contained in the topic to the user terminal T.

To be specific, as shown in FIG. 9(a), in the case where all of assignable weights are assigned to Topic B by the user terminal T at the time of receiving selection of a topic with weights, the topic presentation unit 13 presents the sub-topics of Topic B to the user terminal T, for example. As the conditions for presenting the sub-topics, the sub-topics of one topic may be generated when at least a predetermined percentage (for example, 50%) of weights among all weights to be assigned to topics are assigned to the one topic, for example.

In the case where the topic generation unit 11 generates a plurality of topics in a hierarchical manner by a clustering technique such as LDA, for example, the topic presentation unit 13 can obtain the sub-topics (Topics B1 to B5) located in the lower level than Topic B from the topic storage unit 22. Then, the topic presentation unit 13 presents Topics A, B1 to B5, Topics C, D and E at the next opportunity to present the topics to the user as shown in FIG. 9(b).

The sub-topics may be generated by, when the receiving unit 14 receives selection of a topic with a predetermined amount or more of weights, mechanically classifying the words contained in the topic again by a clustering technique such as LDA, for example.

Further, when the receiving unit 14 receives selection of a topic with a predetermined amount or more of weights from the user terminal T, the topic presentation unit 13 may extract a topic that is similar to the topic with a certain degree or higher from the topic storage unit and present them to the user terminal T. The degree of similarity between topics can be obtained by a known language analysis technique on a group of words contained in each topic.

Note that, when the sub-topics are generated, the product profile generation unit 12 may generate a product profile again in accordance with the generated sub-topics.

Further, the topic presentation unit 13 may present a merged topic in which a plurality of topics other than the topic for which selection with a predetermined amount or more of weights is received among a plurality of topics presented to the user terminal T are merged to the user terminal T.

For example, in the case where all of assignable weights are assigned to Topic B at the time of receiving selection of a topic with weights as shown in FIG. 9(a) and Topics B1 to B5, which are the sub-topics of Topic B, are generated as shown in FIG. 9(b), the topic presentation unit 13 may present Topic α, which is the merged topic where Topics A and C are merged, and Topic β, which is the merged topic where Topics D and E are merged, as shown in FIG. 9(c).

In the case where the topic generation unit 11 generates a plurality of topics in a hierarchical manner by a clustering technique such as LDA, for example, the topic presentation unit 13 can obtain the topics located in the higher level than Topics A, C, D and E as the merged topic from the topic storage unit 22.

Further, when the receiving unit 14 receives selection of a topic with a predetermined amount or more of weights, the topic generation unit 11 may generate a merged topic by merging two or more topics. As topics merged into the merged topic, the topics that are similar to each other with a certain degree or higher may be selected, for example. The degree of similarity between topics can be obtained by a known language analysis technique on a group of words in each topic.

In the case where selection of the merged topic presented to the user terminal T is received, the extraction unit 15 may generate a user profile by distributing the weights assigned to the merged topic to the respective topics before merging. Further, when the merged topic is generated, the product profile generation unit 12 may generate a product profile again in accordance with the generated merged topic.

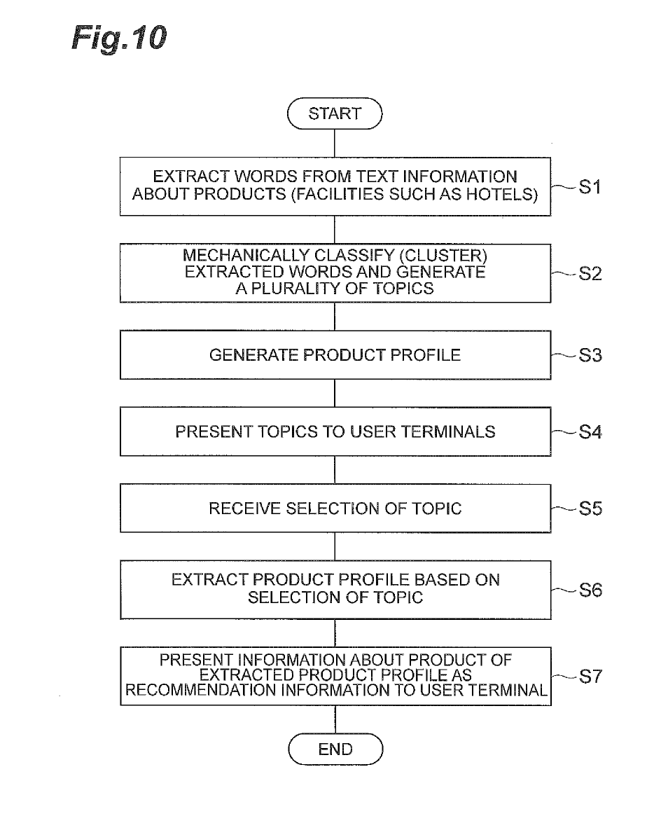

A recommendation information presentation method according to this embodiment is described hereinafter with reference to FIG. 10. FIG. 10 is a flowchart showing an example of a process of a recommendation information presentation method in the recommendation information presentation device 1 shown in FIG. 2.

First, the topic generation unit 11 mechanically extracts words from text information about a plurality of products (for example, facilities such as hotels) acquired from the content database 21 by a technique such as morphological analysis, for example (S1). Next, the topic generation unit 11 classifies the words extracted from the text information by a mechanical clustering technique and thereby generates a plurality of topics (S2). Then, the product profile generation unit 12 generates a product profile indicating the tendency of distribution of the words contained in the text information about products over topic for each product (S3).

Then, the topic presentation unit 13 presents the words contained in at least two of the topics generated by the topic generation unit 11 for each topic to the user terminal T (S4). After that, the receiving unit 14 receives selection of a topic from the user terminal T in response to the presentation of the topics by the topic presentation unit 13 (S5).

Then, the extraction unit 15 extracts a product profile based on the selection of a topic received by the receiving unit 14 (S6). To be specific, the extraction unit 15 generates a user profile, which is information indicating the tendency of selection of a topic by a user, based on the selection of a topic by the user and then extracts the product profile indicating the tendency of distribution that coincides with the tendency of selection indicated by the user profile with a certain degree or higher.

After that, the recommendation information presentation unit 16 presents information about the product associated with the product profile extracted by the extraction unit 15 as recommendation information to the user terminal T (S7).

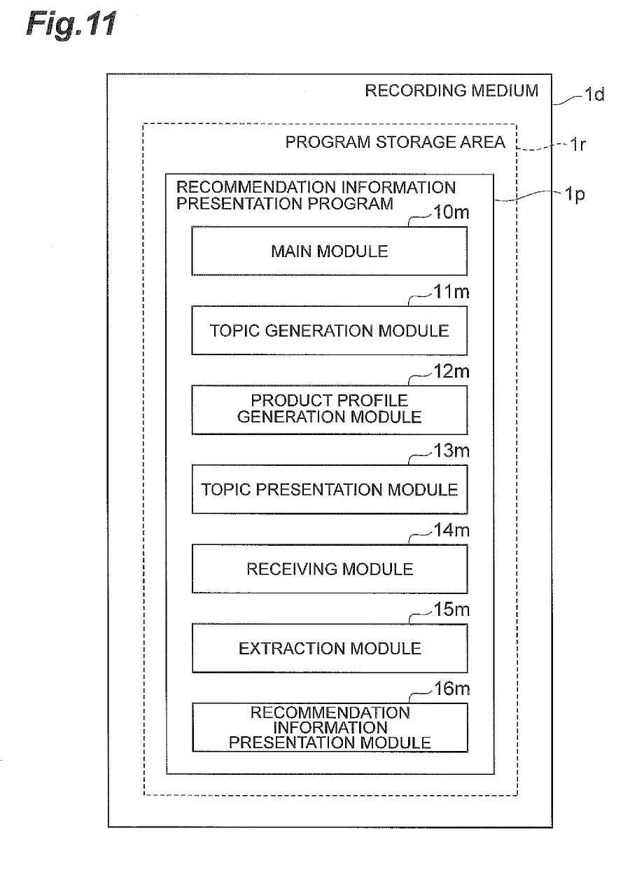

Hereinafter, a recommendation information presentation program that causes a computer to function as the recommendation information presentation device 1 is described with reference to FIG. 11. A recommendation information presentation program 1p includes a main module 10m, a topic generation module 11m, a product profile generation module 12m, a topic presentation module 13m, a receiving module 14m, an extraction module 15m, and a recommendation information presentation module 16m.

The main module 10m is a part that exercises control over the recommendation information presentation processing. The functions implemented by executing the topic generation module 11m, the product profile generation module 12m, the topic presentation module 13m, the receiving module 14m, the extraction module 15m and the recommendation information presentation module 16m are respectively equal to the functions of the topic generation unit 11, the product profile generation unit 12, the topic presentation unit 13, the receiving unit 14, the extraction unit 15 and the recommendation information presentation unit 16 of the recommendation information presentation device 1 shown in FIG. 2.

The recommendation information presentation program 1p is provided through a recording medium 1d such as CD-ROM or DVD-ROM or semiconductor memory, for example. Further, the recommendation information presentation program 1p may be provided as a computer data signal superimposed onto a carrier wave over a communication network.

According to the recommendation information presentation device 1, the recommendation information presentation method and the recommendation information presentation program 1p of the embodiment described above, topics formed by mechanically classifying words extracted from text information about products are presented to a user, a product where the tendency of selection of a topic by a user coincides with the tendency of distribution of words contained in the text information about products over topics with a certain degree or higher is extracted, and information about the extracted product is presented as recommendation information to the user. Specifically, topics are generated mechanically without human intervention. Further, the extraction of a product to be presented according to the tendency of selection of a topic by a user is performed based on the distribution of words contained in the text information about products over topics. Thus, it is possible to make association between a topic to be selected by a user and a product to be presented to the user easily without human intervention and without any bias by a provider of the product.

An embodiment of the present invention is described in detail above. However, the present invention is not limited to the above-described embodiment. Various changes and modifications may be made to the present invention without departing from the scope of the invention.

### REFERENCE SIGNS LIST

1 . . . recommendation information presentation device, 11 . . . topic generation unit, 12 . . . product profile generation unit, 13 . . . topic presentation unit, 14 . . . receiving unit, 15 . . . extraction unit, 16 . . . recommendation information presentation unit, 20 . . . databases, 21 . . . content database, 22 . . . topic storage unit, 23 . . . product profile storage unit, 1d . . . recording medium, 1p . . . recommendation information presentation program, 10m . . . main module, 11m . . . topic generation module, 12m . . . product profile generation module, 13m . . . topic presentation module, 14m . . . receiving module, 15m . . . extraction module, 16m . . . recommendation information presentation module

1. A recommendation information presentation device comprising:
at least one memory operable to store computer program instructions;
at least one processor operable to read said program instructions and operate according to said program instructions, said program instructions including:
topic generation instructions configured to cause at least one of said at least one processor to mechanically classify words extracted from text information about a plurality of products and generate a plurality of topics made up of one or more classified words;
product profile generation instructions configured to cause at least one of said at least one processor to generate a product profile containing a frequency of appearance of words in each topic obtained by classifying the words contained in the text information about products into one or more topics for each of the products;
topic presentation instructions configured to cause at least one of said at least one processor to present words contained in at least two topics among the topics generated by the topic generation instructions to a user terminal for each topic;
receiving instructions configured to cause at least one of said at least one processor to receive selection of a topic from the user terminal in response to presentation of topics; and
recommendation information presentation instructions configured to cause at least one of said at least one processor to present information about a product associated with the product profile in accordance with a tendency of selection of a topic by a user of the user terminal received as recommendation information to the user terminal.

2. The recommendation information presentation device according to claim 1, wherein
the topic presentation instructions are further configured to cause at least one of said at least one processor to present two topics, and
the receiving instructions are further configured to cause at least one of said at least one processor to receive selection of any one topic among the two topics presented.

3. The recommendation information presentation device according to claim 2, wherein
the topic presentation instructions are further configured to cause at least one of said at least one processor to calculate a degree of similarity between a word contained in one topic generated by the topic generation instructions and a word contained in another topic generated by the topic generation instructions as a distance between topics, and presents the one topic and the another topic with a predetermined distance or more.

4. The recommendation information presentation device according to claim 2, wherein
the topic presentation instructions are further configured to cause at least one of said at least one processor to select one topic generated by the topic generation instructions, specify another topic in which a frequency of appearance of a word is less than a predetermined frequency in any product profile where a frequency of appearance of the word contained in the one selected topic is equal to or more than a predetermined frequency, and present the one topic and the another topic.

5. The recommendation information presentation device according to claim 1, wherein
the topic presentation instructions are further configured to cause at least one of said at least one processor to present three or more topics, and
the receiving instructions are further configured to cause at least one of said at least one processor to receive selection of at least one topic among the three or more topics presented by the topic presentation instructions.

6. The recommendation information presentation device according to claim 5, wherein
the receiving instructions are further configured to cause at least one of said at least one processor to receive selection of one or more topics with weights, and
the recommendation information presentation instructions are further configured to cause at least one of said at least one processor to present the recommendation information based on the tendency of selection by a user indicated by the selection of topics with weights.

7. The recommendation information presentation device according to claim 6, wherein
when selection of one or more topics with a predetermined amount or more of weights is received from the user terminal, the topic presentation instructions cause at least one of said at least one processor to present a plurality of sub-topics made up of a plurality of words formed by mechanically classifying a plurality of words contained in the topic to the user terminal.

8. The recommendation information presentation device according to claim 7, wherein
the topic presentation instructions are further configured to cause at least one of said at least one processor to present a merged topic where a plurality of topics other than a topic for which selection with a predetermined amount or more of weights is received among a plurality of topics presented to the user terminal are merged to the user terminal.

9. A recommendation information presentation method in a recommendation information presentation device for presenting recommendation information about a product to a user terminal, the method by at least one processor in said device and comprising:
mechanically classifying words extracted from text information about a plurality of products and generating a plurality of topics made up of one or more classified words;
generating a product profile containing a frequency of appearance of words in each topic obtained by classifying the words contained in the text information about products into one or more topics in association with each of the products;
presenting words contained in at least two topics among the topics generated to a user terminal for each topic;
receiving selection of a topic from the user terminal in response to presentation of topics; and
presenting information about a product associated with the product profile in accordance with a tendency of selection of a topic by a user of the user terminal received as recommendation information to the user terminal.

10. (canceled)
